(19) United States
(12) Patent Application Publication
(10) Pub. No.: US 2018/0211237 A1
(43) Pub. Date: Jul. 26, 2018

(54) SYSTEM AND METHOD FOR TRANSFERRING AN ELECTRONIC RECEIPT TO A USER DEVICE

(71) Applicant: Navaneethakrishnan SUBBAIYA, CHENNAI (IN)

(72) Inventor: Navaneethakrishnan SUBBAIYA, CHENNAI (IN)

(21) Appl. No.: 15/870,241

(22) Filed: Jan. 12, 2018

(30) Foreign Application Priority Data
Jan. 12, 2017 (IN) 201741001290

(51) Int. Cl. G06Q 20/20; G06Q 20/32; G06F 3/12

(52) U.S. Cl. CPC G06Q 20/202; G06Q 20/3278; G06F 3/129; G06F 3/1298; G06F 3/1219

(57) ABSTRACT

A system and method for transferring electronic receipts to a user device is disclosed. In some embodiments, the system comprises, a point of sale device configured for generating a receipt in the electronic file format, and a beamer device comprising, a processor configured for fetching the electronic receipt from the point of sale device, an input/output module configured for receiving at least a selection of a channel among one or more channels from a user of the user device for transferring the electronic receipt to the user device, wherein the one or more channels comprises at least one of a Bluetooth, Near Field Communication, Tethering or phone-as-modem (PAM), Wi-Fi and Internet, and a communication module configured for communicating the electronic receipt to the user device through the selected the selected channel.

This application claims priority from Indian patent application 201741001290, filed on 12 Jan. 2017, incorporated herein by reference.

### TECHNICAL FIELD

The present disclosure in general relates point of sale terminal devices and electronic transactions and more particularly relates to method(s) and system(s) for transferring electronic receipt to a user device.

### BACKGROUND

Generally a financial transaction refers to an agreement, communication or movement carried out between two entities, for example, between a buyer and seller to exchange a product, service or any asset for payment. In various day to day transactions, the buyers or consumers of goods or services typically receive receipts from their merchants or seller as a proof of the transactions. Generally, such receipts are written acknowledgment that contains information such as information pertaining to the seller, date of purchase, transaction ID, details of customer's purchase including itemized products and services, unit prices, subtotals, taxes and totals, terms and conditions for example. The receipts are maintained by both the entities for various purposes. For example, sellers keep receipts for internal accounting, tracking of sales, revenue, etc. On the other hand, receipts are maintained by the buyers as a proof of purchase, for returning or replacing the product or service, tax reporting purpose, reimbursement, provisioning warranties, etc. Moreover, the receipts are maintained to keep track of expenditure and budgeting purpose.

For in-store purchases or transactions, for example in supermarkets, shopping malls, grocery stores, restaurants, etc., the consumer obtains printed paper receipts at point of sale terminals. A point of sale terminal typically comprises a computer, a credit/debit card reader and a barcode scanner and a printer associated with the computer. When the consumer completes the product selection process and approaches an operator/attender of point of sale terminal, the operator scans the products using barcode scanner, creates log of products, receives payment and then generates a receipt which is printed using the printer. The printed receipt is then handed over to the consumer as a proof of transaction.

Generally the consumers retain most of the paper receipts for days, weeks and even years after the transactions various purposes described above, i.e., as a proof of transaction, for claiming warranty, for returning, replacing or re-selling the product or service, tax reporting purpose, reimbursement and many other uses. For example, an employee may need to retain all the receipts associated with business expenses to submit to an employer at the end of the month or year for reimbursement or for tax purposes. In another example, a person may need to retain all the receipts associated with electronic good purchases for few years to claim warranty, services and for many other purposes. As the number of transactions increases it is difficult and inconvenient in many ways for the consumers to retain all the receipts for executed transactions. For example, for most of the consumers/users, it is time consuming endeavour to locate a particular paper receipt when needed, paper receipts are easily misplaced, difficult to organize as the paper receipts may come in different sizes and shapes, fades away too quickly, and the like. Further, chemicals used in thermal receipt paper are harmful to human health.

As described, the paper receipts adds an overhead to the consumers, at the same time, printing receipts and handing over the printed receipts is a time consuming task for cashiers. Further, adds an overhead cost to the merchant/seller to stock papers for printing receipts and thermal papers used in thermal receipt printers pose environment threats.

### SUMMARY OF THE DISCLOSURE

Thus there exists a need for a system and method which mitigates at least some of the disadvantages of the state of the art.

This summary is provided to introduce a selection of concepts in a simple manner that are further described in the detailed description of the disclosure. This summary is not intended to identify key or essential inventive concepts of the subject matter nor is it intended for determining the scope of the disclosure.

A system and method for transferring electronic receipts to a user device is disclosed. In some embodiments, the system comprises, a point of sale device configured for generating a receipt in the electronic file format, and a beamer device comprising, a processor configured for fetching the electronic receipt from the point of sale device, an input/output module configured for receiving at least a selection of a channel among one or more channels from a user of the user device for transferring the electronic receipt to the user device, wherein the one or more channels comprises at least one of a Bluetooth, Near Field Communication, Tethering or phone-as-modem (PAM), Wi-Fi, and Internet, and a communication module configured for communicating the electronic receipt to the user device through the selected the selected channel.

Also disclosed is a method for transferring an electronic receipt to a user device, the method comprising the steps of, generating, by a point of sale device, a receipt in the electronic file format, fetching, by a beamer device, the electronic receipt from the point of sale device, receiving, by the beamer device, at least a selection of a channel among one or more channels from a user of the user device for transferring the electronic receipt to the user device, wherein the one or more channels comprises at least one of a Bluetooth, Near Field Communication, Tethering or phone-as-modem (PAM), Wi-Fi, and Internet, and communicating, by the beamer device, the electronic receipt to the user device through the selected channel.

### BRIEF DESCRIPTION OF THE FIGURES

The disclosure will be described and explained with additional specificity and detail with the accompanying figures in which:

FIG. 1 illustrates an exemplary system for transferring electronic receipt to a user device in accordance with an embodiment of the present disclosure;

FIG. 2 illustrates an example beamer device in accordance with an embodiment of the present disclosure;

FIG. 3 is a detailed block diagram of the exemplary system for transferring electronic receipt to a user device in accordance with an embodiment of the present disclosure;

FIG. 4 illustrates an exemplary user interface of the beamer device 115 in accordance with an embodiment of the present disclosure;

FIG. 5A and 5B illustrates an example method of transferring electronic receipt to a user device using Bluetooth channel in accordance with an embodiment of the present disclosure;

FIG. 6 illustrates another example method of transferring electronic receipt to a user device using NFC channel in accordance with an embodiment of the present disclosure; and

FIG. 7 is a flowchart illustrating a method of transferring electronic receipt to a user device in accordance with an embodiment of the present disclosure.

Further, persons skilled in the art to which this disclosure belongs will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having benefit of the description herein.

### DETAILED DESCRIPTION OF THE EXEMPLARY EMBODIMENTS

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

The embodiments herein disclose a method and system for transferring electronic receipt to a user/consumer device in a point of sale terminal (POS terminal) where retail transaction completes. At the point of sale terminal, consumer presents the products that he wish to purchase, merchant calculate the amount owed by the consumer, indicates the amount, receives payment for the same from the consumer, and prepares receipt for the transaction. In one embodiment of the present disclosure, the system generates an electronic receipt and the generated electronic receipt is transferred to a user device associated with the consumer. The term ‘receipt’ as described herein refers to the transaction record in a paper format or electronic format, handed over to the user upon purchase of commodities, services and the like.

In accordance with an embodiment of the present disclosure, the system comprises a point of sale terminal configured for generating an electronic receipt upon a successful transaction, and a beamer device, in electronic communication with the point of sale terminal. In some embodiments, the beamer device is configured for, receiving the electronic receipt from the point of sale terminal, receiving at least a selection of one or more channels for transferring the electronic receipt from a user/consumer of the user device, transferring the electronic receipt to the user device through the selected one or more channels, wherein the selected one or more channels include at least one of a Print, Bluetooth, Near Field Communication, Tethering, or phone-as-modem (PAM), Wi-Fi and Internet. In one embodiment of the present disclosure, the system provides plug and play devices/solution that may be integrated with any existing POS computer/system without altering the POS computer hardware or software components.

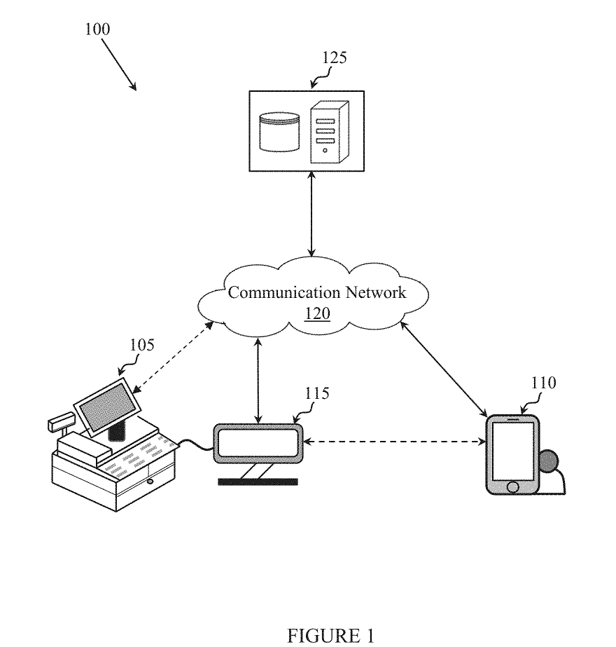

FIG. 1 illustrates an exemplary system for transferring electronic receipt to a user device in accordance with an embodiment of the present disclosure. As shown, the system, 100 comprises a point of sale device 105 (POS device), a user device 110 and a beamer device 115, and optionally a server 120 configured to serve the needs of the system for example, for storing the electronic receipts of each individual users of the system, analysing the electronic receipts and the like. In some implementation, the POS device 105 and the user device 110 are communicatively connected to the server 125 through a communication network 120. The POS device 105 and the beamer device 115 are communicatively connected through USB as shown.

The POS device 105 may be a general purpose computer or a special purpose computer physically located at a check-out lane in a store. That is, the POS device 105 may be a retail or wholesale computer, which may be embodied as a desktop computer, a laptop computer, a tablet computer, a personal digital assistant or other computing devices. Hence, the POS device 105 may include one or more processors, associated processing modules, interfaces (for example, a scanner, keyboard, display monitor, network interface modules or the like), and storage devices communicatively interconnected to one another through one or more communication means or channels for processing sales data, for calculating the amount owed by a consumer and generating receipt for a transaction. Further, the POS device 105 may be coupled with one or more payment devices for receiving payments from consumers. Typically, the POS device 105 may be any known POS device capable of conducting sales transactions and generating the receipts for the transactions, wherein the receipts comprises content relating to the transactions.

The user device 110 may be any mobile computing device that often accompanies their users to perform daily activities. By way of example, the user device 110 may include portable computing device such as a smartphone, tablet, a personal data assistant (PDA), a notebook computer, and the like. The user device 110 may communicate with the server 125 through the communication network 120 in one or more ways such as wired, wireless connections. In one embodiment of the present disclosure, the user device 110 communicates with the beamer device 115 using at least one of Bluetooth, Near Field Communication (NFC), Tethering or phone-as-modem (PAM), Wi-Fi and Internet.

In one embodiment of the present disclosure, the user device 110 comprises an e-receipt management application configured for receiving, storing and managing one or more electronic receipts associated with the one or more transactions. The e-receipt management application is a downloadable application and may require one time registration by the user. That is, a user/consumer may register and create a profile by providing necessary credentials such as username, password, contact details, email address, and the like. On successful registration, the server 125 creates a user profile and the information pertaining to the user, electronic receipts and transaction related information are recorded and updated in the user profile for further analysis and usage by the user. Such information may be recorded locally in the user device 110 or in a database associated with the server 115. In some implementations, a unique QR code is generated for every user profile for user identification. The generated unique QR code of the user is stored in user device 110. The unique QR code of the user is used for identifying the user at the point of sale. In some implementations, the e-receipt management application automatically synchronizes the electronic receipts with the server 125 and remotely manages the one or more electronic receipts stored in the server 125. That is, the e-receipt management application provides a user interface for the user to receive, store, manage and analyse the one or more electronic receipts corresponding to the one or more transactions.

The beamer device 115 may include, by way of example, a computing device running in mobile operating system with beamer application installed in it. In a preferred embodiment of the present disclosure, the beamer device 115 is a dedicated device that is communicatively connected to the POS device 105 through a USB connection. However, the beamer device 115 may be embodied as a desktop computer, a laptop computer, a tablet computer, a personal digital assistant or other computing devices.

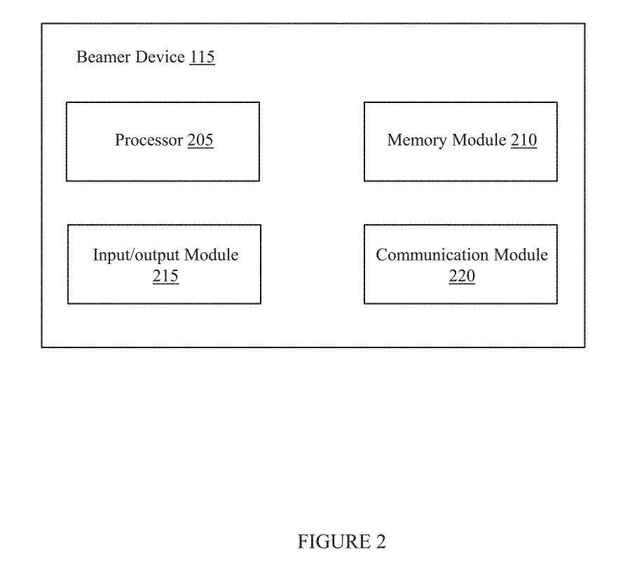

FIG. 2 illustrates an example beamer device in accordance with an embodiment of the present disclosure. As shown, the beam device 115 comprises a processor 205, a module memory 210, an input/output module 215 and a communication module 220. The processor 205 of the beamer device 115 may be embodied as any type of processor capable of executing instructions, such as a microprocessor, digital signal processor, microcontroller or the like. The processor 205 is communicatively coupled to the components of the beamer device 115 via number of signals paths.

The memory 210 may be embodied as or otherwise include one or more volatile and non-volatile memory devices for example, DRAM, SDRAM, EPROM, EEPROM, flash memory devices, and the like. In one embodiment of the present disclosure, the memory 210 stores information/data and instructions to be executed by the processor 205 and stores temporary variables or other intermediate information during processing. Further, the memory module stores the one or more electronic receipts received from the POS device 105 temporarily. The instructions stored in the memory module 210 when executed by the processor 205 communicates/transfers the electronic receipt from the beamer device 115 to the user device 110 through one of the user selected means such as Bluetooth, NFC, Tethering, Wi-Fi, Infrared, etc.

The input/output module 215 may include a touch screen interface that enables the consumers to input their selection to the beamer device 115. That is, the consumer may input preferred mode for receiving electronic receipt using the input/output module 215.

The communication module 220 facilitates communication with the one or more POS device 105 and optionally with the server 125 over the communication network. The communication module 220 may use any suitable wired and/or wireless communication protocol to communicate with the POS device 105 and the server 125 over the communication network 120, depending on, for example, the particular type of network 120. In a preferred embodiment of the present disclosure, the beamer device 115 is directly connected to the POS device 105 via USB cable or Bluetooth and receives one or more electronic receipts generated by the POS device 105.

In one embodiment of the present disclosure, the communication module 220 comprises a contactless communication mechanism. For example, the communication module 220 may include Near Field Communication (NFC) circuitry, Bluetooth circuitry, infrared circuitry, Tethering, or phone-as-modem (PAM) circuitry, Wi-Fi, internet circuitry, and the like, to transfer electronic receipts to the user device 110. Now referring back to FIG. 1, in one embodiment of the present disclosure, based on the user selection, the beamer device 115 may utilize a dedicated communication network (NFC, Infrared, Bluetooth, Tethering or phone-as-modem (PAM), Wi-Fi Hotspot, Internet and the like) to transfer the electronic receipts to the user device 110. Alternatively, the beamer device 115 may utilize the communication network 120 (Internet or Wi-Fi) to transfer the electronic receipts to the user device 110 based on the user selection.

Referring to FIG. 1, the server 125 may include a computer server or a network of computers or a virtual server, which provides functionalities or services for other programs or devices such as user device 110. In some embodiments, the server 125 may be a computer server dedicated for storing electronic receipts corresponding to one or more transactions associated with the one or more users. The server 125 may include one or more processors, associated processing modules, interfaces and storage devices (electronic receipt databases), electronic receipt management module and the like, communicatively interconnected to one another through one or more communication means or channels for receiving, processing and communicating electronic receipts corresponding to one or more transactions. Transaction may include purchase transaction, return transaction, or any other type of transaction that may be documented for historical preservation, record keeping or both.

In one embodiment of the present disclosure, the server 125 maintains a user database that comprises information pertaining to the registered users. As described, the server 125 maintains a record of all the electronic receipts corresponding to one or more transactions of the one or more users/consumers. Further, the server 125 records information describing one or more aspects or details of the transactions. For example, in some embodiments, an electronic receipt may include information corresponding to the date that a product or service was purchased, the description of the product or service purchased, the price of the product or service, the name of the merchant, the location from which the product or service was purchased, the technical specifications of the product or service, the warranty information associated with the product or service, the return policy of the merchant, and any other information describing the details of a transaction. Furthermore, the server 125 may fetch and record various other information or documents pertaining to the transactions such information or documents may include user manual, service manual, warranty information or any other form of content describing an aspect of the product or service or the transaction itself. Hence, the server 125 organizes all the electronic receipts and other related information and the same is made available to the user of the user device 110. Similarly, the server 125 maintains a merchant database wherein the merchant transactions are recorded for future reference.

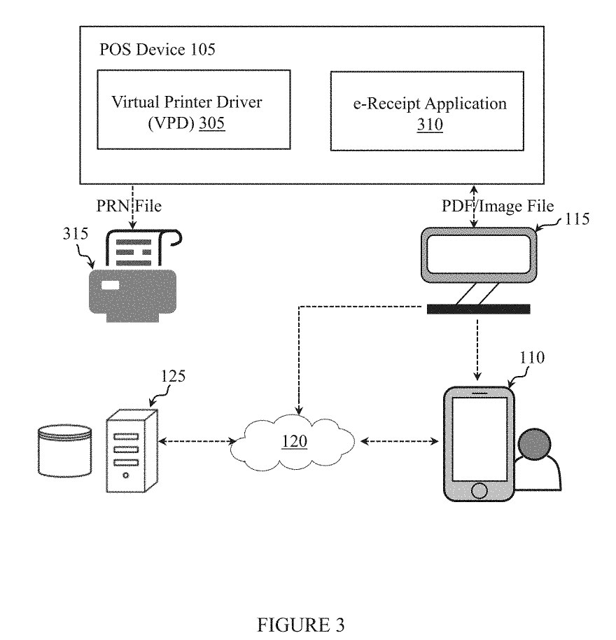

FIG. 3 is a detailed block diagram of the exemplary system for transferring electronic receipt to a user device in accordance with an embodiment of the present disclosure. As shown, in one embodiment of the present disclosure, the POS device 110 comprises a virtual printer driver 305 and an e-Receipt application 310. In one implementation, the virtual printer driver 305 is configured as a default printer driver. The virtual printer driver 305 converts print stream or receipt data into one or more formats such as PDF, image formats (BMP, TIFF, JPEG, PNG) and also generates a print ready file for example, PRN file. That is, when a cashier/user of the POS device 105 generates a receipt for a transaction and selects print option, the virtual printer driver 305 converts print stream or receipt data into one or more formats such as PDF, image formats (BMP, TIFF, JPEG, PNG) and also generates a print ready file for example, PRN file. Thus generated PDF, image and PRN files are stored in a local memory (i.e. a designated folder) of the POS device 105. In one embodiment of the present disclosure, the user of the POS device 105 may append one or more coupons, offers, surveys and any form of additional contents to the receipt.

In one embodiment of the present disclosure, the e-receipt application 310 continuously monitors the local memory or the designated folder and transfers the latest electronic receipt and coupon files, if any, in one or more formats such as PDF, image and PRN stored in the folder to the connected beamer device 115. That is, when a new receipt is recorded in the folder, the new receipt is transferred to the beamer device 115 instantaneously as shown in FIG. 3. In a preferred embodiment, the e-receipt application 310 is installed in the beamer device 115 and the beamer device 115 continuously watches for new receipt in the folder. Upon identifying the receipt, the beamer device 115 fetches the receipt from the folder and stores in a memory associated with the beamer device 115. As shown, one beamer device 115 is connected to one POS device 105. However, it has to be noted that one beamer device 115 may be connected more than one POS devices in a retail environment.

In one embodiment of the present disclosure, the beamer device 115 provides one or more options for the user of the user device 110 to receive the electronic receipt from the beamer device 115. In one embodiment of the present disclosure, on receiving the electronic receipt from the POS device 105, the beamer device presents one or more options to the user to receive the electronic receipt on his/her user device 110, wherein the one or more options may include but are not limited a print option (paper receipt), digital receipt option (electronic receipt option) and combination of both, i.e., paper and digital receipt option. That is, on receiving the electronic receipt form the POS device 105, the beamer device 115 waits for the user selection of at least one option/channel for transmitting the electronic receipt to the user of the user device 110. Based on the user selection, the beamer device 115 may provide further options indicating other channels for communicating the electronic receipt to the user device 110. For example, if the user selects “digital receipt” option, then the beamer device 115 further presents one or more options using which the user may receive the electronic receipts, wherein the further one or more options may include but are not limited to Bluetooth, NFC, Tethering or phone-as-modem (PAM), Wi-Fi Hotspot, Internet and the like. On the other hand, if the user selects “paper receipt” option, then the beamer device 115 triggers the POS device 105 to print the receipt and accordingly, the PRN file stored in the POS terminal 105 is sent to receipt printer 315 associated with the POS device 105.

As described, if the user selects “digital receipt” option, then the beamer device 115 waits for further input from the user. If the user selects any one of the channels, for example, NFC, Bluetooth, Tethering or phone-as-modem (PAM), Infrared or Wi-Fi Hotspot, the beamer device 115 establishes a communication link with the user device 115 and the electronic receipt is directly transferred through the selected channel. On the other hand, if the user selects “Internet” option, the electronic receipt may be sent to the server 125 through the communication network 120 and the server 125 in turn pushes the receipt to the user device 110 whenever the user device 110 is connected to Internet.

As described, one or more POS devices may be connected to a single beamer device in a retail environment. In such implementation, one or more electronic receipts may be generated for one or more consumers and are sequentially stored in the beamer device 115 in such a manner that each receipt is made available to one consumer at a time. Further, the consumer may select any of the channels for receiving the receipt on their user device. The manner in which the electronic receipts are transferred to the user device 110 through various channels is described in detail further below.

In a retail environment, the consumer typically picks one or more products from various places within the store and approaches the POS terminal to make the payment and complete the transaction. At the POS terminal, a cashier/user scans the one or more products selected by the consumer and generates a receipt which comprises total bill amount, product and quantity details, merchant information, and the like. Then the cashier may print the receipt using a print option. In one embodiment, upon receiving the print command, the virtual printer driver 305 (default print drive) converts print stream or receipt data into one or more formats (electronic receipt) such as PDF, image formats (BMP, TIFF, JPEG, PNG) and also generates a print ready file for example, PRN file. Thus generated files are stored in the local folder. Further, the e-receipt application pushes the electronic receipt to the beamer device 115. Alternatively, the beamer device 115 may fetch the electronic receipt from the POS device 105. Next, the consumer may approach the beamer device 115 to obtain the receipt as a proof of transaction and for future reference in electronic format. The manner in which the consumer receives the electronic receipt from the beamer device 115 to the user device 110 is described in detail further below.

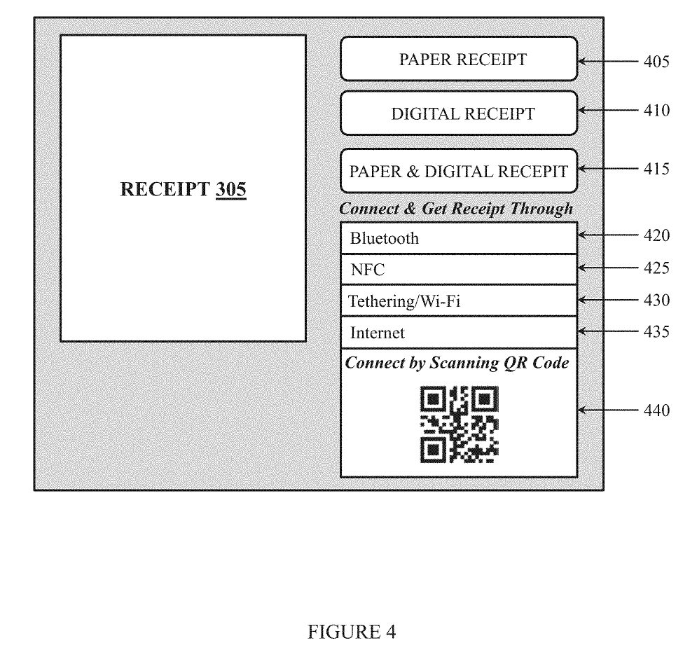

FIG. 4 illustrates an exemplary user interface of the beamer device 115 in accordance with an embodiment of the present disclosure. As shown, on receiving the electronic receipt (for example, in PDF file), the beamer device 115 displays the receipt along with various options/channels using which the user of the user device 110 may receive the receipt in digital format. For example, the beamer device 115 provides a “paper receipt” option 405, “digital receipt” option 410 and “paper and digital receipt” option 415.

Referring to FIG. 4, if the consumer selects the “paper receipt” option 405, the beamer device 115 communicates at least an instruction to the POS device 105 for printing the receipt and the POS device 105 prints the PRN file stored in the local folder through the receipt printer 315. On the other and, if the consumer selects the “paper and digital receipt” 415, then the beamer device 115 communicates the print instructions to the POS device 105 and prompts other options to receive the electronic receipt on the user device. Further, if the consumer selects the “digital receipt” option 410, the beamer device 115 provides further one or more options as shown, using which the consumer may receive the digital receipt to his/her user device 110 and waits for the user response. The further one or more options/channels may include but not limited to a Bluetooth option 420, NFC option 425, Tethering/Wi-Fi option 430, Internet option 435 and QR code option 440.

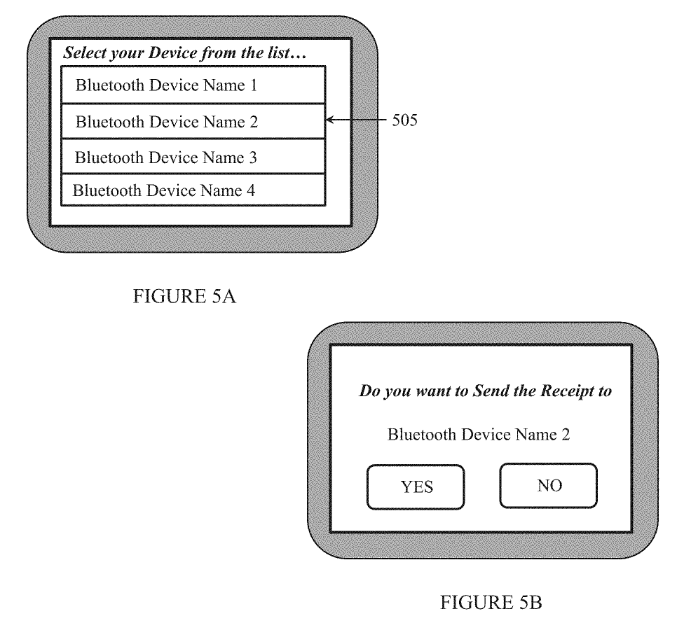

In some embodiments, if the consumer selects “Bluetooth” option 420, both the beamer device 115 and the user device 110 are paired through Bluetooth and digital receipt is transmitted to the user device 110 via Bluetooth. FIG. 5A and 5B illustrates an example method of transferring electronic receipt to a user device using Bluetooth channel in accordance with an embodiment of the present disclosure. When the consumer selects the “Bluetooth” option 420, the beamer device 115 scans the nearby Bluetooth devices and lists down the available Bluetooth devices (device IDs) on the screen as shown in FIG. 5A. The consumer may select his/her user device name in the list, for example “Bluetooth Device Name 2” 505. On selecting the user device, a confirmation window appears on the beamer device 115 as shown in FIG. 5B. Upon consumer confirmation, pairing is performed and the digital receipt is transferred via Bluetooth. The received electronic receipt is stored in the user device (e-receipt management application) and may be synced with the server 125 for future reference and analysis.

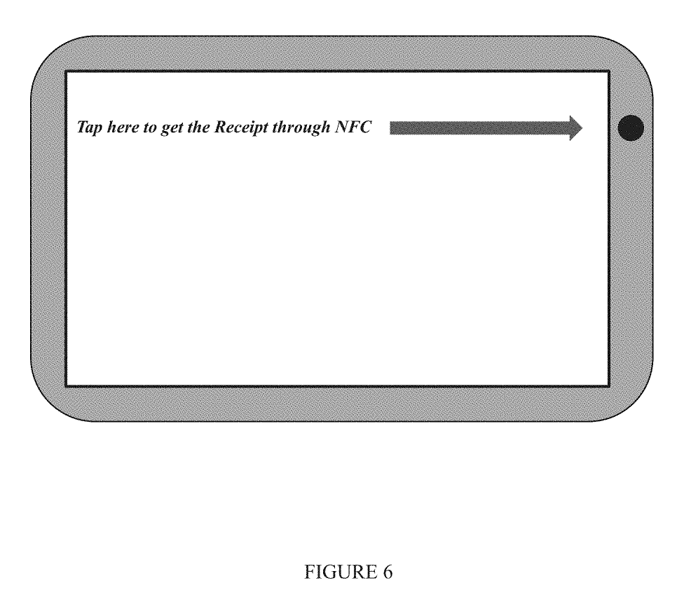

FIG. 6 illustrates another example method of transferring electronic receipt to a user device using NFC channel in accordance with an embodiment of the present disclosure. Referring to FIG. 4 and FIG. 6, for example, if the user device 110 is NFC enabled, then the consumer may select NFC option 425 for receiving the electronic receipt. On selecting NFC option 425, the beamer device 115 directs the consumer to tap his/her user device in proximity of the beamer device 115 as shown in FIG. 6. When the consumer brings his/her user device in close proximity to the beamer device 115, the beamer device 115 transfers the electronic receipt to the user device 110 and the received electronic receipt is stored in a local memory, the local memory associated with the e-receipt management application.

Referring back to FIG. 4, If the consumer selects “tethering/Wi-Fi option” 430, Tethering or phone-as-modem (PAM) is used as a digital channel to establish connection between the beamer device 115 and the user device 110. The digital receipt is transferred to the user device 110 once the connection is successfully established to the Beamer device 115 hotspot. As shown, when the user selects Tethering/Wi-Fi 430, Tethering is enabled in Beamer device 115 and a QR code 440 is generated with Beamer device's name, Hotspot Name, assigned IP, receipt file path (or) URL. Once the consumer scans the QR code 440, the connection is established between Beamer device 115 and the user device 110 and a URL associated with the digital receipt is transferred to the user device 110 thereby enabling the consumer to download the receipt on the user device 110.

In some implementations, the electronic receipt is transferred to the user device 110 through Internet. When the user selects “Internet” option 435, the beamer device 115 prompts the user to generate and show unique QR code of the user device to the QR code reader in beamer device 115. The unique QR code of the user contains user account details such as user ID, contact number, email ID and the like. The beamer device 115 reads the user's account details when the user shows the QR code to QR code reader of the beamer device 115 and then the beamer device 115 uploads the receipt to server 125. The receipt is stored in the server 125 and may be later downloaded/synced to user device 110. In some other implementations, the electronic receipt is transferred to the user device 110 through Internet using the mobile number entered by the user in the Beamer device. When the user selects “Internet” option 435, the beamer device 115 prompts the user to enter the registered mobile number and to submit. Beamer validates the consumer details and uploads receipt to server 125.

In some other implementations, the receipt may be encoded as a QR code by the beamer device 115 and the encoded receipt may be received by scanning the QR code. In some other embodiments, QR code may be used as medium to establish Bluetooth or Wi-Fi connection between the beamer device 115 and the user device 110. In such a scenario, the beamer device 115 generates a QR code which contains beamer device information such as but not limited to device name, Bluetooth ID, information pertaining to connected network (Wi-Fi) and the like. Once the user scan the QR code using the e-receipt management application installed on the user device 110, one of the Bluetooth or Wi-Fi connections is established between the beamer device 115 and the user device 110 for transferring the electronic receipt to the user device 110.

As described, the user may establish a communication channel between the beamer device 115 and the user device 110 once the receipt is generated or when the user wishes to get the electronic receipt. However, in some embodiments, the user may establish a communication channel between the beamer device 115 and the user device 110 at any time. For example, connection with beamer device 115 may be established by the consumer while waiting in POS queue or before making the purchase by scanning the QR code sticker displayed in POS checkout line. As described, the QR code is used as medium to establish Bluetooth or Wi-Fi connection between the beamer device 115 and the user device 110. Once the consumer is reached check-out, the consumer may just select his/her device from the “connected device list” to get the receipt. This saves considerable amount of check-out time at POS terminal and hence improve in-store experience of the user.

In one embodiment of the present disclosure, the received receipts are synced with the server 125 in real-time, near real-time or when the user device 110 is connected to the internet. Hence, the server 125 maintains a record of all the electronic receipts corresponding to the one or more transactions along with the transaction details. Hence, the system and method disclosed in the present disclosure, eliminates the need of paper receipts in any transactions and provides an easy access for all the receipts and transaction details pertaining to the consumer.

In another embodiment of the present disclosure, server 125 maintains a merchant database in which documents associated with merchants are stored. Similar to the consumer profile, each merchant may create a profile in the server 125 by providing necessary information. Once created, the transaction details associated with the merchant is stored in the server 125. Hence, the merchant may keep track of all the transactions, customers, customer purchase behaviour and the like.

In an example scenario, a user/consumer makes necessary purchases and approaches the POS terminal to complete the transaction. At the POS terminal the merchant scans the product, receives the payment for the purchased goods or services and generates a receipt as a proof of transaction. Once the merchant triggers to print the receipt, the receipt is electronically stored in a local folder in PDF and print ready format, for example, PRN file. The manner in which the receipt is transferred to a user device is described in detail further below.

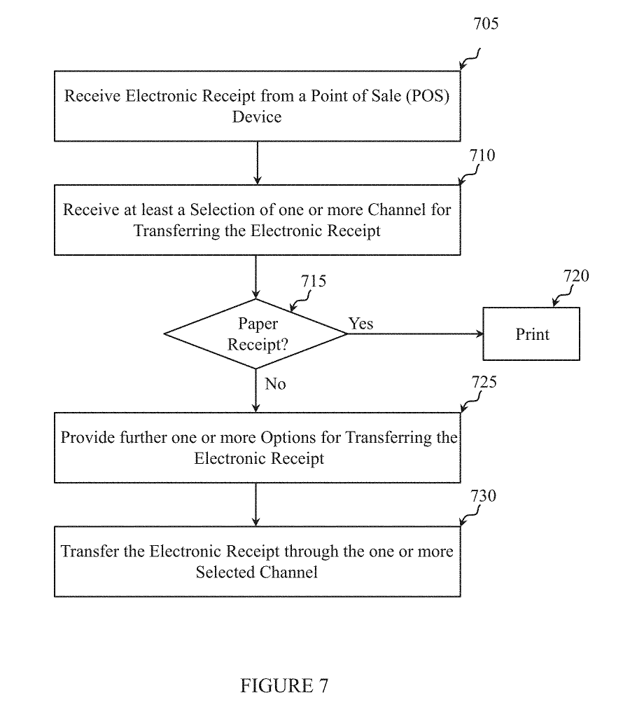

FIG. 7 is a flowchart illustrating a method of transferring electronic receipt to a user device in accordance with an embodiment of the present disclosure. At step 705, the beamer device 115 receives electronic receipt from the point of sale device 105. That is, the e-receipt application running on the POS device 105 pushes the electronic receipt when the receipt gets generated.

At step 710, the beamer device 115 receives at least a selection of one or more channels for transferring the electronic receipt. That is, when the beamer device 115 receives the electronic receipt from the POS device 105, the beamer device 115 provides one or more options using which the user may receive the electronic receipt to his/her user device 110, wherein the one or more option may include a paper receipt, digital receipt and paper and digital receipt. Further, the beamer device 115 waits for the user selection.

At step 715, if the user selects paper receipt option, then the beamer device 115 trigger the POS device 105 to print the print ready file stored locally in the POS device 105. The receipt is printed using a receipt printer as shown in step 720. On the other hand, if the user selects the digital receipt option, then the control passes to step 725.

At step 725, the beamer device 115 provides further one or more options for transferring the electronic receipt, wherein the further one or more options/channels may include a Bluetooth option, NFC option, Wi-Fi option, Internet option and QR code option. Further, the beamer device 115 waits for the user selection.

At step 730, the beamer device 115 transfers the electronic receipt through the one or more selected channel. That is, on receiving the input from the user, the beamer device 115 establishes a communication channel with the user device 110 for transferring the electronic receipt to the user device 110.

The system and method disclosed in the present disclosure provides various channels using which a user may get the electronic receipts for their transactions. Hence, the method and system for transferring receipt electronically saves time and cost for retailer and ease the receipts maintenance for the customer.

Further, the method and system eliminates the paper based receipt handling system while still providing digital receipt as the confirmation of sale to the customer at POS terminal. The system may be integrated with any existing POS terminals without altering their current POS system, with minimal modifications.

Further, the server lists the one or more receipts with option to organize or group or sort by date, merchant, expense category, etc. Hence the consumer may get the insights on the spending by means of charts, graphs, etc. Further, various algorithms may be implemented at the server to perform one or more of spend analysis, credit analysis, loyalty management and the like; thus assisting the users and merchants in monitoring expenses and revenue opportunities respectively.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A system for transferring an electronic receipt to a user device, the system comprising:
a point of sale device configured for generating a receipt in an electronic file format; and
a beamer device comprising:
a processor configured for fetching the electronic receipt from the point of sale device;
an input/output module configured for receiving at least a selection of a channel among one or more channels from a user of the user device for transferring the electronic receipt to the user device, wherein the one or more channels comprises at least one of a Bluetooth, Near Field Communication, Tethering or phone-as-modem (PAM), Wi-Fi, and Internet; and
a communication module configured for communicating the electronic receipt to the user device through the selected channel.

2. The system as claimed in claim 1, wherein the user device is further configured for syncing the electronic receipt with a server.

3. The system as claimed in claim 1, wherein the communication module comprises at least one of a Near Field Communication (NFC) circuitry, Bluetooth circuitry, infrared circuitry, Tethering, or phone-as-modem (PAM) circuitry, Wi-Fi, internet circuitry, and the like.

4. A method of transferring an electronic receipt to a user device, the method comprising:
generating, by a point of sale device, a receipt in the electronic file format;
fetching, by a beamer device, the electronic receipt from the point of sale device;
receiving, by the beamer device, at least a selection of a channel among one or more channels from a user of the user device for transferring the electronic receipt to the user device, wherein the one or more channels comprises at least one of a Bluetooth, Near Field Communication, Tethering or phone-as-modem (PAM), Wi-Fi, and Internet;
establishing, by the beamer device, a communication channel with the user device; and
communicating, by the beamer device, the electronic receipt to the user device through the selected the selected channel.
